(19) United States
(12) Patent Application Publication
(10) Pub. No.: US 2013/0250206 A1
(43) Pub. Date: Sep. 26, 2013

(54) Liquid Crystal Display Supporting Module and Liquid Crystal Displaying Monitor

(71) Applicants: Jiahe Cheng, Shenzhen (CN); Chong Huang, Shenzhen (CN)

(72) Inventors: Jiahe Cheng, Shenzhen (CN); Chong Huang, Shenzhen (CN)

(73) Assignee: SHENZHEN CHINA STAR OPTOELECTRONICS TECHNOLOGY CO. LTD., Shenzhen (CN)

(21) Appl. No.: 13/512,640

(22) PCT Filed: Apr. 14, 2012
(86) PCT No.: PCT/CN12/73868

§ 371 Date: May 30, 2012

(30) Foreign Application Priority Data
Mar. 26, 2012 (CN) 201210082660.X

(51) Int. Cl. G02F 1/1333

(52) U.S. Cl. 349/59

(57) ABSTRACT

The present invention provides a liquid crystal display module comprises a plastic middle frame having a front wall located at a displaying plane, and a sidewall located at a sidewall of the displaying plane. A driving chip is securely disposed on external surface of the sidewall of the middle frame. A metallic shield is securely disposed distant to the external surface of the sidewall of the middle frame to shield the driving chip from EMI. The present invention further discloses a liquid crystal display monitor. By the provision of a metallic shield, the driving chip can be prevented from being affected by EMI.

### FIELD OF THE INVENTION

The present invention relates to a technology field of display, and more particularly to a liquid crystal display supporting module and a liquid crystal display monitor.

### DESCRIPTION OF PRIOR ART

As shown in FIG. 1, a conventional liquid crystal display (LCD) monitor is assembled by firstly attaching the LCD module to the supporting frame 12, and then a front frame 11 is assembled to the supporting frame 12 by means of snap-in or screws. Then a LCD monitor is completed.

In general, a galvanized sheet metal is used to configure the front frame. However, in order to reduce the cost, the galvanized sheet metal has been replaced by a frame made from plastic material. Even the system integration manufacturers have adopted this practice and the plastic front frame has been used both for the LCD monitor and the LCD module. However, it has been widely known to the skill in the art that the plastic material can not shield the electromagnetic interference (EMI). Since there is a lot of electronic components assembled within the LCD module, such as a driving chip which is vulnerable to the EMI. As a result, a protection to such electronic component is extremity important and necessary.

### SUMMARY OF THE INVENTION

The present invention provides a middle frame and a liquid crystal display monitor to resolve the prior art issues and with a metallic shield provided, the driving chip can be prevented from EMI.

In order to resolve the prior art issues, the present invention provides a liquid crystal display module configured with a plastic middle frame, a driving chip, a metallic shield and a backframe. The plastic middle frame includes a front wall located at a displaying plane, and a sidewall located at a sidewall of the displaying plane. The sidewall of the plastic middle frame is defined with retaining grooves. The driving chip is securely disposed on external surface of the sidewall of the middle frame. A metallic shield is securely disposed distant to the external surface of the sidewall of the middle frame to shield the driving chip from EMI, and retained within the retaining grooves. And a backframe attached to the middle frame.

Wherein the metallic shield is provided with retaining tabs at ends and which are securely received within the retaining grooves.

Wherein the supporting module further includes a printed circuit board which is securely attached to backframe and electrically interconnected to the driving chip via conductive wires.

Wherein the supporting module further includes a plastic lid covering the printed circuit board.

Wherein the supporting module further includes a chip-on-film deployed over the driving chip so as to securely attach the driving chip on the external surface of the sidewall of the plastic middle frame.

Wherein the conductive wires are embedded within the chip-on-film.

In order to resolve the prior art issues, the present invention provides a liquid crystal display module comprises a plastic middle frame having a front wall located at a displaying plane, and a sidewall located at a sidewall of the displaying plane. A driving chip is securely disposed on external surface of the sidewall of the middle frame. A metallic shield is securely disposed distant to the external surface of the sidewall of the middle frame to shield the driving chip from EMI.

Wherein the external wall of the sidewall of the plastic middle frame is defined with retaining grooves in which the metallic shield is securely attached therein.

Wherein the metallic shield is provided with retaining tabs at ends and which are securely received within the retaining grooves.

Wherein the supporting module further includes a backframe on which a printed circuit board is securely attached, the backframe is securely assembled to the middle frame, the printed circuit board is electrically interconnected to the driving chip via conductive wires.

Wherein the supporting module further includes a plastic lid covering the printed circuit board.

In order to resolve the prior art issues, the present invention provides a liquid crystal display monitor configured with a liquid crystal display supporting module and a plastic front frame. The monitor comprises a plastic front frame having a front wall located on a displaying surface, and a sidewall located at a sidewall of the displaying plane. The supporting module includes a plastic middle frame which includes a front wall located at a displaying plane, and a sidewall located at a sidewall of the displaying plane. A driving chip is securely disposed on external surface of the sidewall of the middle frame. A metallic shield is securely disposed between the driving chip and the sidewall of the middle frame to shield the driving chip from EMI.

Wherein the external wall of the sidewall of the plastic middle frame is defined with retaining grooves in which the metallic shield is securely attached therein.

Wherein the metallic shield is provided with retaining tabs at ends and which are securely received within the retaining grooves.

Wherein the supporting module further includes a backframe on which a printed circuit board is securely attached, the backframe is securely assembled to the middle frame, the printed circuit board is electrically interconnected to the driving chip via conductive wires.

Wherein the liquid crystal display monitor further includes a liquid crystal display panel supported on the plastic middle frame. A plastic lid covers the printed circuit board. And a plastic front frame engages to the plastic lid so as to securely support the liquid crystal display panel.

The present invention can be concluded with the following advantages: as differentiated from the existing prior art, the metallic shield is arranged on the plastic middle frame in a position adjacent to the driving chip so as to prevent the driving chip from being negatively affected by the EMI.

### BRIEF DESCRIPTION OF DRAWINGS

FIG. 1 is an illustrational view of a backframe of a prior art LCD backframe;

FIG. 2 is a perspective view of a LCD supporting module made in accordance with a preferred embodiment of the present invention;

FIG. 3 is a cross sectional view of the LCD supporting module taken along line S-S in FIG. 2; and

FIG. 4 is a cross sectional view of a LCD supporting module and LCD monitor implemented with the embodiments shown in FIGS. 2 and 3.

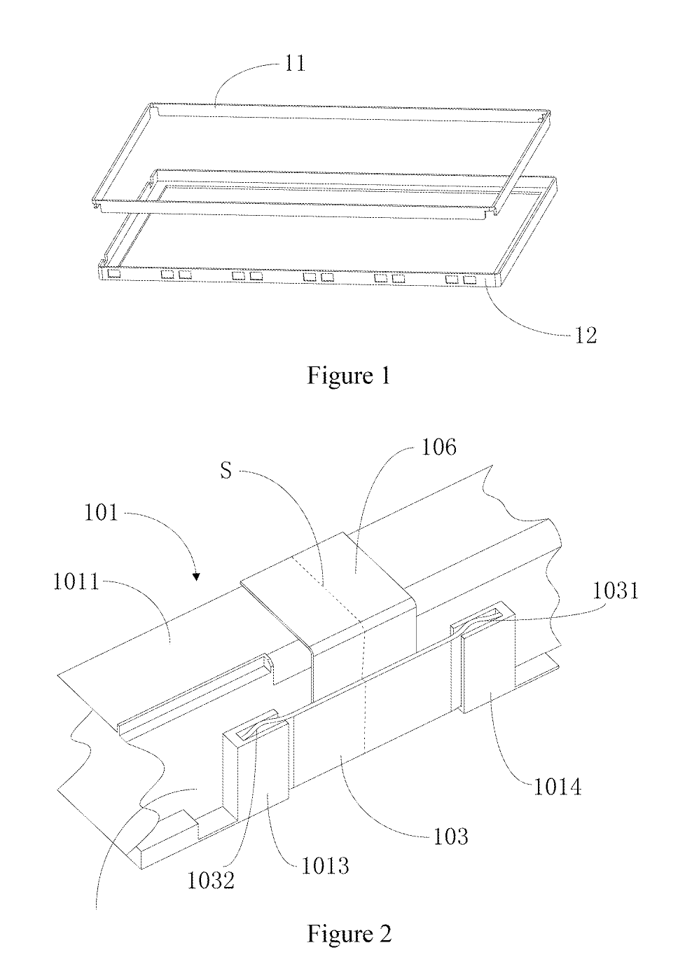

### DETAILED DESCRIPTION OF PREFERRED EMBODIMENTS

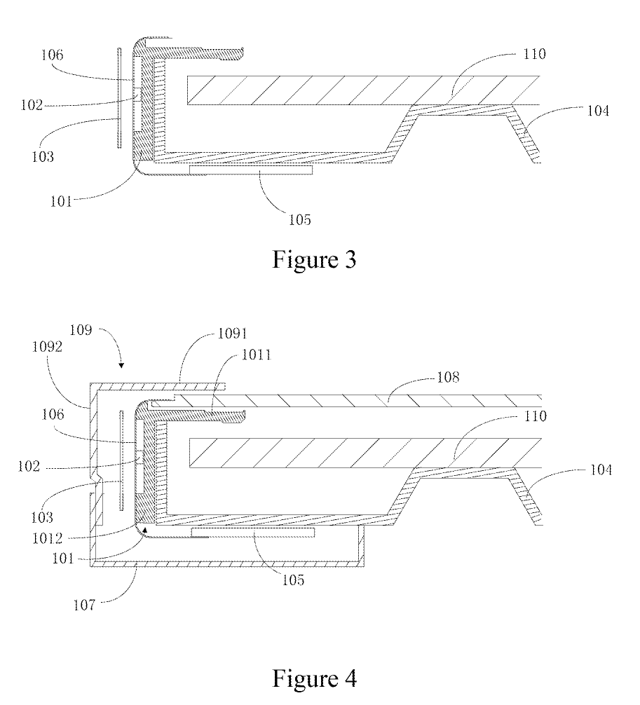

Referring to FIGS. 2 and 3, FIG. 2 is a perspective view of a LCD supporting module made in accordance with a preferred embodiment of the present invention; and FIG. 3 is a cross sectional view of the LCD supporting module taken along line S-S in FIG. 2. The LCD module made in accordance with the present invention includes a plastic middle frame 101, a driving chip 102, and a metallic shield 103. The driving chip 102 is securely attached to the plastic middle frame 101. The metallic shield 103 is secured to the plastic middle frame 101 in an area adjacent to the driving chip 102 so as to shield the external EMI to the driving chip 102.

As shown in FIG. 2, the plastic middle frame 101 includes a front wall 1011 which is located on a displaying plane of the LCD supporting module, and a sidewall 1012 which is located on a side of the displaying plane. Referring to FIG. 3, the driving chip 102 is securely attached to the chip-on-film 106 and which is in turn securely attached to an outer surface of the sidewall 1012. By this arrangement, the driving chip 102 is securely attached to the external surface of the sidewall 1012. The chip-on-film 106 can be glued to the sidewall 1012 of the middle frame 101. The metallic shield 103 is securely attached in a position which is distant to an outer surface of the sidewall 1012 of the middle frame 101. In this preferred embodiment, the sidewall 1012 of the middle frame 101 is defined with retaining grooves 1013 and 1014, and the metallic shield 1013 and 1014 can be retained therein. Retaining tabs are formed on the ends of the metallic shield 103, and which can be securely retained within the grooves 1013 and 1014. The tabs can be configured with an “S-shaped” configuration with which the tabs can be readily engaged within the grooves 1013 and 1014. Its resuming force will securely retain the tabs within the grooves 1013 and 1014.

In the preferred embodiment, the metallic shield 103 can be securely attached by other means, such as glue or screws. By these measurements, the metallic shield 103 can still be attached to the middle frame 101 adjacent to the driving chip 102. Accordingly, the present invention will not be limited to this embodiment.

Referring to FIG. 3, the LCD supporting module further includes a backframe 104, and a printed circuit board 105. The backframe 104 and the middle frame 101 are assembled together, and the printed circuit board 105 is attached to the backframe 104. The printed circuit board 105 is electrically interconnected to the driving chip 102 by means of conductive wires. The LCD supporting module further includes a plastic lid 107 which covers the printed circuit board 105 to provide a protection thereof.

The conductive wires are disposed within the chip-on-film 106 (COF, chip-on-film).

Referring to FIG. 4 which is a cross sectional view of a LCD supporting module and LCD monitor implemented with the embodiments shown in FIGS. 2 and 3. As shown in FIG. 4, the LCD supporting module further includes a LCD panel 108 and a plastic front frame 109. The LCD panel 108 is supported by the middle frame 101, and then the plastic front frame 109 is engaged with the plastic lid 107 so as to securely position the LCD panel 108. The driving chip 102 is electrically interconnected to the LCD panel 108 by those conductive wires embedded within the chip-on-film 106.

The plastic front frame 109 includes a front wall 1091 arranged on a displaying surface of the LCD supporting module and a sidewall 1092 located on a sidewall of the displaying surface. The plastic middle frame 101 is arranged within the plastic front frame 109. In addition, the external outer surface is the sidewall 1012 of the plastic middle frame 101 extends toward the sidewall 1092 of the plastic front frame 109. In the preferred embodiment, the front wall 1011 of the plastic middle frame 101 is parallel to the front wall 1091 of the plastic front frame 109. As clearly disclosed in FIG. 4, the driving chip 102 is disposed within a space between the front wall 1011 of the plastic middle frame 101, and the front wall 1091 of the plastic front frame 109, and the metallic shield 102 is disposed between the driving chip 102 and the front wall 1091 of the plastic front frame 109.

Accordingly, the present invention provides a LCD supporting module and a LCD monitor made therefrom. By the provision of the metallic shield 103 attached to the plastic middle frame 101 and located adjacent to the driving chip 102, the driving chip 102 can be well protected and shielded from EMI.

The above described is merely preferred embodiment of the present invention, and it is merely for illustration while not for limitation. As a result, any alternation and modification or any equivalents based on the specification as well as the drawings will be covered by the attached claims even they are applied to other fields of technology directly or indirectly.

1. A liquid crystal display module, comprising
a plastic middle frame including a front wall located at a displaying plane, and a sidewall located at a sidewall of the displaying plane, the sidewall of the plastic middle frame being defined with retaining grooves;
a driving chip securely disposed on external surface of the sidewall of the middle frame;
a metallic shield securely disposed distant to the external surface of the sidewall of the middle frame to shield the driving chip from EMI, and retained within the retaining grooves; and
a backframe attached to the middle frame.

2. The liquid crystal display supporting module as recited in claim I, wherein the metallic shield is provided with retaining tabs at ends and which are securely received within the retaining grooves.

3. The liquid crystal display supporting module as recited in claim I, wherein the supporting module further includes a printed circuit board which is securely attached to backframe and electrically interconnected to the driving chip via conductive wires.

4. The liquid crystal display supporting module as recited in claim 3, wherein the supporting module further includes a plastic lid covering the printed circuit board.

5. The liquid crystal display supporting module as recited in claim 3, wherein the supporting module further includes a chip-on-film deployed over the driving chip so as to securely attach the driving chip on the external surface of the sidewall of the plastic middle frame.

6. The liquid crystal display supporting module as recited in claim 5, wherein the conductive wires are embedded within the chip-on-film.

7. A liquid crystal display module, comprising
a plastic middle frame including a front wall located at a displaying plane, and a sidewall located at a sidewall of the displaying plane;
a driving chip securely disposed on external surface of the sidewall of the middle frame;
a metallic shield securely disposed distant to the external surface of the sidewall of the middle frame to shield the driving chip from EMI.

8. The liquid crystal display supporting module as recited in claim 7, wherein the external surface of the sidewall of the middle frame is defined with retaining grooves in which the metallic shield is securely attached therein.

9. The liquid crystal display supporting module as recited in claim 8, wherein the metallic shield is provided with retaining tabs at ends and which is securely received within the retaining grooves.

10. The liquid crystal display supporting module as recited in claim 7, wherein the supporting module further includes a backframe on which a printed circuit board is securely attached, the backframe is securely assembled to the middle frame, the printed circuit board is electrically interconnected to the driving chip via conductive wires.

11. The liquid crystal display supporting module as recited in claim 10, wherein the supporting module further includes a plastic lid covering the printed circuit board.

12. A liquid crystal display monitor configured with a liquid crystal display supporting module and a plastic front frame, comprising:
a plastic front frame having a front wall located on a displaying surface, and a sidewall located at a sidewall of the displaying plane;
the supporting module including:
a plastic middle frame including a front wall located at a displaying plane, and a sidewall located at a sidewall of the displaying plane;
a driving chip securely disposed on external surface of the sidewall of the middle frame; and
a metallic shield securely disposed between the driving chip and the sidewall of the middle frame to shield the driving chip from EMI.

13. The liquid crystal display monitor as recited in claim 12, wherein the external surface of the sidewall of the middle frame is defined with retaining grooves in which the metallic shield is securely attached therein.

14. The liquid crystal display monitor as recited in claim 13, wherein the metallic shield is provided with retaining tabs at ends and which is securely received within the retaining grooves.

15. The liquid crystal display monitor as recited in claim 12, wherein the supporting module further includes a backframe on which a printed circuit board is securely attached, the backframe is securely assembled to the middle frame, the printed circuit board is electrically interconnected to the driving chip via conductive wires.

16. The liquid crystal display monitor as recited in claim 15, further comprising:
a liquid crystal display panel supported on the plastic middle frame;
a plastic lid covering the printed circuit board; and
a plastic front frame attached to the plastic lid so as to securely support the liquid crystal display panel.
